(19) United States
(12) Patent Application Publication
(10) Pub. No.: US 2024/0199928 A1
(43) Pub. Date: Jun. 20, 2024

(54) Two-Pack Polyurethane Composition

(71) Applicants: Dow Global Technologies LLC, Midland, MI (US); Rohm and Haas Company, Collegeville, PA (US)

(72) Inventors: Yinzhong Guo, Pearland, TX (US); Daniele Vinci, Luzern (CH); Thorsten Schmidt, Richterswil (CH); Franca Arrighi, Mozzate (IT)

(21) Appl. No.: 18/286,917

(22) PCT Filed: Apr. 21, 2022
(86) PCT No.: PCT/US2022/025700

§ 371 Date: Oct. 13, 2023

Related U.S. Application Data
(60) Provisional application No. 63/195,377, filed on Jun. 1, 2021.

(51) Int. Cl. C09J 175/06; C08G 18/10; C08G 18/50

(52) U.S. Cl. CPC C09J 175/06; C08G 18/10; C08G 18/5021; C08G 18/5084; C09J 2475/00

(57) ABSTRACT

Provided is a 2-pack adhesive composition comprising I) pack I, which comprises a prepolymer composition (PCB), wherein the prepolymer composition (PCB) comprises one or more isocyanate functional prepolymers (FPA), wherein the isocyanate functional prepolymer (FPA) comprises polymerized units of 4,4′ MDI, and wherein the prepolymer composition (PCB) comprises a total amount of all isocyanate monomers of 0 to 0.2% by weight based on the weight of prepolymer composition (PCB). and II) CA pack II, which comprises one or more amine functional polyols. Also provided is a method of making a laminate using such a 2-pack adhesive composition.

Adhesives are useful for a variety of purposes, including for example, for bonding two sheets or films together to form a laminate. Laminates are useful for a variety of purposes, including, for example, packages that contain food and packages that contain non-food goods. One useful class of adhesives is the class of urethane adhesives. Some useful urethane adhesives are provided as two-pack compositions, in which one pack (“pack I”) contains an isocyanate functional prepolymer, and the other pack (“pack II”) contains one or more isocyanate-reactive compounds, often including one or more polyols.

Often, it is desired to make the isocyanate functional prepolymer by reacting one or more isocyanate monomers with one or more isocyanate-reactive compounds. It is also often desired that the finished isocyanate functional prepolymer contains no leftover isocyanate monomer or contains at most a very small amount of leftover isocyanate monomer to reduce the risks (environmental, health, and/or safety) from handling the product during its application. It is also independently desired that the isocyanate functional prepolymer has a relatively low viscosity.

The isocyanate-reactive compounds in pack II are desirably chosen to provide the mixed adhesive composition (that is, the mixture of pack I with pack II) with desirable properties. Usually, when pack I and pack II are brought into contact with each other, a cure process begins in which the isocyanate groups in pack I react with the isocyanate-reactive groups in pack II, and the viscosity of the mixture begins to rise. It is desirable that the mixture has a sufficiently long pot life; that is, initially, the rise in viscosity is slow enough to allow the mixture to be thoroughly blended, to allow for a layer of the blended mixed adhesive to be applied to first substrate, and to allow for a second substrate to be brought into contact with that layer, usually through a lamination process. It is also desired that, subsequently, the cure time is relatively short; that is, that the bond formed by the adhesive composition between the substrates becomes usefully strong relatively quickly after completion of the processes of applying the adhesive composition to the substrates and, if performed, the lamination process. It is independently desired that the final strength of the bond is usefully high. It is also independently desired that the adhesive composition does not develop bubbles during the cure process.

US 2004/0122253 describes an MDI/polypropylene polyether prepolymer suitable for use in adhesive compositions optionally also comprising a curative for isocyanate groups.

It is desired to provide a process for producing an isocyanate functional prepolymer that has one or more of the desirable features described herein above. It is also desired to provide an isocyanate functional prepolymer that has one or more of the desirable features described herein above. It is also desired to provide a two-pack adhesive composition that has one or more of the desirable features described herein above. It is also desired to provide a process for producing a laminate, where that process has one or more of the desirable features described herein above.

The following is a statement of the invention.

A first aspect of the present invention is a 2-pack adhesive composition comprising
I) pack I, which comprises a prepolymer composition (PCB), wherein the prepolymer composition (PCB) comprises one or more isocyanate functional prepolymers (FPA),
   wherein the isocyanate functional prepolymer (FPA) comprises polymerized units of 4,4′ MDI, and
   wherein the prepolymer composition (PCB) comprises a total amount of all isocyanate monomers of 0 to 0.2% by weight based on the weight of prepolymer composition (PCB),
and
II) pack II, which comprises one or more amine functional polyols.

A second aspect of the present invention is a process for producing a laminate comprising
a) bringing pack I and pack II of the composition of the first aspect into contact with each other to form a laminating adhesive,
b) applying a layer of the laminating adhesive to a surface of a first film,
c) then bringing the layer of the laminating adhesive into contact with a surface of a second film to form a laminate.

A third aspect of the present invention is a laminate produced by the method of the second aspect.

A fourth aspect of the present invention is a 2-pack adhesive composition comprising
I) pack I, which comprises a prepolymer composition (PCB), wherein the prepolymer composition (PCB) comprises one or more isocyanate functional prepolymers (FPA),
   wherein the isocyanate functional prepolymer (FPA) comprises polymerized units of 4,4′ MDI, and
   wherein the prepolymer composition (PCB) comprises a total amount of all isocyanate monomers of 0 to 0.2% by weight based on the weight of prepolymer composition (PCB),
and
II) pack II, which comprises one or more phosphate functional polyols.

A fifth aspect of the present invention is a process for producing a laminate comprising
a) bringing the pack I and the pack II of the composition of the fourth aspect into contact with each other to form a laminating adhesive,
b) applying a layer of the laminating adhesive to a surface of a first film,
c) then bringing the layer of the laminating adhesive into contact with a surface of a second film to form a laminate.

A sixth aspect of the present invention is a laminate produced by the method of the fifth aspect.

The following is a detailed description of the invention.

As used herein, the following terms have the designated definitions, unless the context clearly indicates otherwise.

An isocyanate compound has one or more isocyanate groups in its molecule. A diisocyanate is a compound that has exactly two isocyanate groups per molecule. A polyisocyanate is a compound that has two or more isocyanate groups per molecule. An isocyanate monomer is an isocyanate compound that has molecular weight of 300 or less. MDI is methylene diphenyl diisocyanate. Common isomers of MDI are 2,2′ MDI; 2,4′ MDI; and 4,4′ MDI. As used herein, the term “MDI,” when used without designating a specific isomer, means any isomer or mixture of isomers of MDI.

As used herein, an “isocyanate-reactive compound” has one or more isocyanate-reactive groups. As used herein, the phrase “isocyanate-reactive group” refers to a chemical group that reacts readily with an isocyanate group. Examples of isocyanate-reactive groups include hydroxyl groups and amine groups.

A diol has exactly two hydroxyl groups per molecule. A polyol has two or more hydroxyl groups per molecule. A polyether polyol is a polyol that has two or more ether linkages in its molecule in addition to two or more hydroxyl groups. A polyester polyol is a polyol that has two or more ester linkages in its molecule in addition to two or more hydroxyl groups. A polyurethane polyol is a polyol that has two or more urethane linkages in its molecule in addition to two or more hydroxyl groups. An amine functional polyol is a polyol that contains one or more tertiary amine groups in addition to two or more hydroxyl groups. A phosphate functional polyol has structure (I):

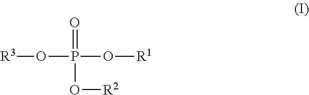

where each of R¹, R², and R³ is independently hydrogen or an organic group. One or more of R¹, R², and R³ are organic groups with at least one carbon atom. Structure (I) contains two or more hydroxyl groups (not shown in structure I), each of which is attached in some way to one or more of R¹, R², and R³.

An isocyanate functional prepolymer is the reaction product of reactants that include one or more polyisocyanate and one or more isocyanate-reactive compound that has two or more isocyanate-reactive groups per molecule. An isocyanate functional prepolymer has one or more unreacted isocyanate groups.

A 2-pack composition is a composition in which two compositions, labeled pack I and pack II, are stored separately and are intended to be then are brought into contact with each other and mixed together to form a combined composition. Usually, the combined composition is formed a relatively short time before it is intended to use the combined composition. Usually, it is expected that some or all of the ingredients of pack I will react with some or all of the ingredients of pack II, and that the reaction will start soon after the packs are combined. In some cases, the combined composition is exposed to temperature above room temperature in order to promote the reaction.

As used herein, a film is an object that is 1 mm or smaller in one dimension and is 10 cm or larger in each of the other two dimensions. A “surface” of a film refers herein to a surface that is perpendicular to the dimension in which the film is 1 mm or smaller. A laminate is an object that has a layer of an adhesive composition bonded to a surface of a first film and also bonded to a surface of a second film.

As used herein, when a process is said to include a step of “reacting” two or more reactants, it is to be understood that the two or more reactants are brought into contact with each other and that they react chemically with each other. The reactants may react with each other spontaneously, or the reaction may be promoted by application of one or more of raised temperature above room temperature, agitation, applied pressure, or other stimulus.

As used herein, room temperature means approximately 23° C.

As used herein, a solvent is a compound that is liquid at 25° C. and that has boiling point of 150° C. or less.

ASTM refers to test methods published by ASTM International, West Conshohocken, PA, USA. ISO refers to test methods published by the International Organization for Standardization, Geneva, Switzerland.

Ratios presented herein are characterized as follows. For example, if a ratio is said to be 3:1 or greater, that ratio may be 3:1 or 5:1 or 100:1 but may not be 2:1. This characterization may be stated in general terms as follows. When a ratio is said herein to be X:1 or greater, it is meant that the ratio is Y:1, where Y is greater than or equal to X. For another example, if a ratio is said to be 15:1 or less, that ratio may be 15:1 or 10:1 or 0.1:1 but may not be 20:1. In general terms, when a ratio is said herein to be W:1 or less, it is meant that the ratio is Z:1, where Z is less than or equal to W.

The present invention involves a process for making prepolymer composition (PCB) that contains one or more isocyanate functional prepolymer (FPA) and that contains little or no isocyanate monomer. This process includes reacting one or more isocyanate monomers (IMA) with one or more polyols (PA). Preferably, isocyanate monomer (IMA) comprises MDI. Preferably, the amount of MDI in isocyanate monomer (IMA) is, by weight based on the total weight of isocyanate monomer (IMA), 50% or more; more preferably 75% or more; more preferably 90% or more; more preferably 99% or more. Preferably, isocyanate monomer (IMA) comprises 4,4′ MDI. Preferably, the amount of 4,4′ MDI in isocyanate monomer (IMA) is, by weight based on the total weight of isocyanate monomer (IMA), 50% or more; more preferably 75% or more; more preferably 90% or more; more preferably 95% or more.

Preferably, polyol (PA) contains one or more polyether polyol. Preferably, the amount of polyether polyol in polyol (PA) is, by weight based on the weight of polyol (PA), 50% or more; more preferably 75% or more; more preferably 90% or more. Preferred polyether polyols are made by polymerization of monomers that include ethylene oxide or propylene oxide or a mixture thereof. Preferably, the amount of polyether polyol that was made by polymerization of monomers that included both ethylene oxide and propylene oxide is, by weight based on the weight of polyol (PA), 50% or more; more preferably 75% or more; more preferably 90% or more.

Preferably, prior to any reaction between isocyanate monomer (IMA) and polyol (PA), the mole ratio of isocyanate groups to hydroxyl groups is 2:1 or higher; more preferably 3:1 or higher; more preferably 3.5:1 or higher. Preferably, prior to any reaction between isocyanate monomer (IMA) and polyol (PA), the mole ratio of isocyanate groups to hydroxyl groups is 8:1 or lower; more preferably 6:1 or lower; more preferably 5:1 or lower.

In the process of making prepolymer composition (PCB), isocyanate monomer (IMA) and polyol (PA) are brought into contact with each other to form reactant mixture (RMA). It is contemplated that, in some embodiments, additional ingredients other than isocyanate monomer (IMA) and polyol (PA) may be present in reactant mixture (RMA). Preferably, the amount of ingredients other than isocyanate monomer (IMA) and polyol (PA) is, by weight based on the weight of the reactant mixture (RMA), 20% or less; more preferably 10% or less; more preferably 5% or less; more preferably 2% or less; more preferably 1% or less.

Preferably, reactant mixture (RMA) is heated to a temperature above room temperature. Preferred temperature is 50° C. or higher, more preferably 70° C. or higher. Preferred temperature is 90° C. or lower.

It is contemplated that isocyanate monomer (IMA) and polyol (PA) react to form reaction product mixture (RPA). It is contemplated the reaction product mixture (RPA) contains one or more isocyanate functional prepolymer (FPA) and also contains some unreacted isocyanate monomer. Preferably, one or more removal steps are performed to remove isocyanate monomer from the reaction product mixture (RPA).

The step of removing isocyanate monomer from reaction product mixture (RPA) may be performed by any method. Preferred methods involve evaporation of isocyanate monomer, preferably followed by capturing the evaporated isocyanate monomer outside of reaction product mixture (RPA). Such evaporation methods may be, for example, stripping or distillation, either of which may be performed with or without heating reaction product mixture (RPA) above room temperature. Preferably any evaporation method is performed under vacuum conditions; that is, by exposing reaction product mixture (RPA) to pressure below 1 atmosphere. Preferred evaporation processes are performed without adding any solvent to the reaction product mixture (RPA).

At the beginning of the step of removing isocyanate monomer from reaction product mixture (RPA), it is preferred that reaction product mixture (RPA) contains little or no solvent. That is, preferably, the amount of solvent in reaction product mixture (RPA) is, by weight based on the weight of reaction product mixture (RPA), 0 to 25%; more preferably 0 to 10%; more preferably 0 to 5%; more preferably 0 to 2%; more preferably 0 to 1%.

After the step of removing isocyanate monomer from reaction product mixture (RPA), the resulting composition is herein labeled prepolymer composition (PCB). The amount of all isocyanate monomer in prepolymer composition (PCB) is, by weight, based on the weight of prepolymer composition (PCB), 0.2% or less; more preferably 0.15% or less; more preferably 0.1% or less.

Prepolymer composition (PCB) contains one or more isocyanate functional prepolymers (FPA). Isocyanate functional prepolymer (FPA) contains in its molecule, polymerized units of 4,4′ MDI. Preferably the amount of polymerized units of 4,4′ MDI in the molecule of isocyanate functional prepolymer (FPA) is, by weight based on the weight of all polymerized units of polyisocyanate monomers, 50% or more; more preferably 75% or more; more preferably 90% or more; more preferably 95% or more.

Preferably, the amount of isocyanate functional prepolymer (FPA) in prepolymer composition (PCB) is, by weight based on the weight of prepolymer composition (PCB), 50% or more; more preferably 75% or more; more preferably 90% or more; more preferably 95% or more.

The prepolymer composition (PCB) may be used for any purpose. Prepolymer composition (PCB) may be used as itself or as a component in a formulated product. One preferred use of prepolymer composition (PCB) is as part or all of pack I in a 2-pack adhesive composition. Preferably, pack II of the 2-pack adhesive composition contains one or more polyols.

Preferably, the amount of prepolymer composition (PCB) in pack I is, by weight based on the weight of pack I, 50% or more; more preferably 75% or more; more preferably 90% or more; more preferably 95% or more. Preferably, the total amount of all polyols in pack II is, by weight based on the weight of pack II, 50% or more; more preferably 75% or more; more preferably 90% or more; more preferably 95% or more.

Preferably, the weight ratio of pack I to pack II is 15:1 or lower; more preferably 10:1 or lower. Preferably, the weight ratio of pack I to pack II is 1:1 or higher.

Preferably the mole ratio of isocyanate groups in pack I to the isocyanate-reactive groups in pack II is 1:1 or higher; more preferably 1.1:1 or higher. Preferably the mole ratio of isocyanate groups in pack I to the isocyanate-reactive groups in pack II is 3:1 or lower; more preferably 2.5:1 or lower; more preferably 2:1 or lower; more preferably 1.5:1 or lower.

The following is a description of the first aspect of the present invention.

In the first aspect of the present invention, one or more amine functional polyols are present in pack II. Amine functional polyols contain one or more tertiary nitrogen atoms per molecule, more preferably three or more tertiary nitrogen atoms per molecule. Preferred amine functional polyols have structure II:

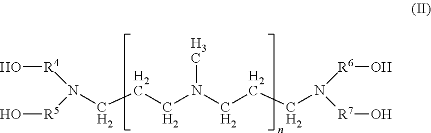

where n is 1 to 5, and where each of R⁴, R⁵, R⁶, and R⁷ is, independently, an organic group containing one or more carbon atoms. Also contemplated are embodiments in which one or more of the hydrogen atoms shown in structure II are replaced by a halogen, a hydroxyl group, an amine group, or an organic group.

The preferred amount of amine functional polymer in pack II is, by weight based on the weight of pack II, 0.5% or more; more preferably 1% or more; more preferably 1.5% or more. The preferred amount of amine functional polymer in pack II is, by weight based on the weight of pack II, 10% or less; more preferably 8% or less; more preferably 6% or less; more preferably 5% or less.

Preferably, pack II additionally contains one or more polyols selected from the group consisting of one or more phosphate functional polyol, one or more polyurethane polyols, and mixtures thereof. More preferably, pack II additionally contains one or more polyurethane polyols. In some embodiments, pack II contains one or more polyester polyol.

When phosphate functional polyol is present in pack II, the preferred amount of phosphate functional polymer is, by weight based on the weight of pack II, 0.5% or more; more preferably 1% or more; more preferably 1.8% or more. When phosphate functional polyol is present in pack II, the preferred amount of phosphate functional polymer is, by weight based on the weight of pack II, 15% or less; more preferably 10% or less; more preferably 6% or less; more preferably 5% or less.

When phosphate functional polyol is present in pack II, preferably one or more polyester polyols is also present. When both phosphate functional polyol and polyester polyol are present, preferably the amount of polyester polyol in pack II is, by weight based on the weight of pack II, 10% or more; more preferably 20% or more; more preferably 30% or more; more preferably 40% or more. When both phosphate functional polyol and polyester polyol are present, preferably the amount of polyester polyol in pack II is, by weight based on the weight of pack II, 99% or less; more preferably 95% or less; more preferably 90% or less.

For use in pack II, when one or more polyurethane polyols are present, preferred polyurethane polyols are reaction products of reactants that include one or more polyisocyanates (PIC) and one or more polyols (PLLC). Preferably, when making a polyurethane polyol, the polyisocyanate (PIC) includes one or more isocyanate monomers (IMC), more preferably one or more isomer of MDI, more preferably 4,4′ MDI. Preferably, when making a polyurethane polyol, the polyol (PLLC) contains one or more polyester polyol. Preferred polyester polyols have molecular weight of 500 or greater; more preferably 1000 or greater. In some embodiments, the polyol (PLLC) contains one or more polyol of molecular weight of 200 or lower; more preferably 150 or lower. Preferably, when making a polyurethane polyol, the polyisocyanate (PIC) and the polyol (PLLC) are reacted using a molar excess of hydroxyl groups over isocyanate groups, so that the resulting polyurethane has residual hydroxyl groups and is therefore a polyurethane polyol.

In some preferred embodiments, pack II contains both one or more polyurethane polyol and one or more amine functional polyol. In such embodiments, the preferred amounts of polyurethane polyol and amine functional polyol are the preferred amounts described herein above. Also contemplated are embodiments in which a polyurethane polyol also contains one or more tertiary amine groups in its molecule, so that the amine functional polyol is also a polyurethane polyol.

Preferably the amount of all ingredients in pack II other than polyols is, by weight based on the weight of pack II, 0 to 10%; more preferably 0 to 5%; more preferably 0 to 2%; more preferably 0 to 1%.

The following is a description of the fourth aspect of the present invention.

In the fourth aspect of the present invention, a phosphate functional polyol is present in pack II. Preferred phosphate functional polyols have two or more ester linkages within each molecule.

Preferably, the amount of phosphate functional polyol in pack II is, by weight based on the weight of pack II, 0.5% or greater; more preferably 1.0% or greater; more preferably 1.8% or greater. Preferably, the amount of phosphate functional polyol in pack II is, by weight based on the weight of pack II, is 15% or less; more preferably 10% or less; more preferably 6% or less; more preferably 5% or less.

Preferably, pack II additionally contains one or more amine functional polyol. Preferably the amount of amine functional polyol is, by weight based on the weight of pack II, 10% or less; more preferably 8% or less; more preferably 6% or less; more preferably 5% or less. Preferably the amount of amine functional polyol is, by weight based on the weight of pack II, 0.5% or more; more preferably 1% or more; more preferably 1.5% or more.

Preferably, the total amount of all polyols in pack II is, by weight based on the weight of pack II; 50% or more; more preferably 75% or more; more preferably 90% or more; more preferably 95% or more.

The following describes the second, third, fifth, and sixth aspects of the present invention.

The 2-pack adhesive composition may be used for any purpose. A preferred purpose is as an adhesive composition. That is, the two packs are brought into contact with each other, and the combined composition is brought into contact with a surface of a substrate. Then a surface of a second substrate is brought into contact with the combined composition. It is contemplated that the isocyanate groups from pack I will react with the isocyanate-reactive groups from pack II and that the combined composition will interact with the surfaces of the two substrates, thus adhering the two substrates together. It is preferred that the pot life of the combined composition is longer than the time required to mix the two packs together and to apply some or all of the combined composition to a surface of a substrate.

Preferably, the combined composition has little or no solvent. That is, preferably the amount of solvent in the combined composition is, by weight based on the weight of the combined composition, 0 to 20%; more preferably 0 to 10%; more preferably 0 to 5%; more preferably 0 to 2%; more preferably 0 to 1%.

Preferably, the first substrate is a film, and the second substrate is a film. Preferably, a layer of the combined composition is applied to a surface of the first substrate, and then a surface of the second substrate is brought into contact with the layer of the combined composition on the surface of the first substrate. The assembled article that contains a first film and a second film with a layer of adhesive composition in contact with a surface of each film is known as a laminate. A combined composition used in this way to form a laminate is known as a laminating adhesive.

Optionally, the combined composition is heated to a temperature above room temperature for the duration of the process of applying a layer of the combined composition to a substrate. Preferred temperature is 30° C. or higher; more preferably 40° C. or higher. Preferred temperature is 80° C. or lower; more preferably 70° C. or lower.

Optionally, when a laminate is formed, the laminate is subjected to external pressure, for example by being pressed between rollers.

In a laminate, the preferred amount of combined composition is 0.5 g/m² or more; more preferably 1 g/m² or more; more preferably 1.5 g/m² or more. In a laminate, the preferred amount of combined composition is 5 g/m² or less; more preferably 3.5 g/m² or less.

The following are examples of the present invention. Operations were performed at room temperature (approximately 23° C.) except where otherwise stated.

Ingredients used were as follows. Each polyol listed in Tables 1A and 1B is not an amine functional polyol, phosphate functional polyol, or a polyurethane polyol unless otherwise noted. Each “polyol mixture” and “formulated polyol” listed in Tables 1A and 1B does not contain any amine functional polyol, phosphate functional polyol, polyurethane polyol, or mixture thereof, unless otherwise noted. “Dow” refers to Dow Inc.

TABLE 1A
Ingredients

| | | Vendor |
|---|---|---|
| Product name | Description | name |
| Voranol ™ PUP 2025 | polyol | Dow |
| Voranol ™ CP 3055 | polyol | Dow |
| CR-89 | formulated polyol | Dow |
| Voranol ™ 425 | polyol | Dow |
| Voranol ™ CP 755 | polyol | Dow |
| Polyol R | Polyester polyol | Dow |
| Polyol S | Polyester polyol | Dow |
| Polyol T | Polyester polyol | Dow |
| Polyol U | polyol | Dow |
| TMP | 1,1,1-Tris(hydroxymethyl)propane | |
| CR-84 | Polyol mixture | Dow |
| CR 121 | polyol | Dow |

TABLE 1B
additional ingredients

| | | Vendor |
|---|---|---|
| Product name | Description | name |
| CR 87-550 | polyol mixture | Dow |
| APP1 | aliphatic polyester polyol | Dow |
| PEP1 | Phosphate ester polyol | Dow |
| Specflex ™ 2306 | Amine initial polyol, structure II | Dow |
| MOR-FREE ™ 88-138 | phosphate functional polyester polyol | Dow |
| MDI | methylene diphenyl diisocyanate | Dow |
| TDI | toluene diisocyanate | Dow |
| Isonate ™ 125M | 98% 4,4′ MDI + 2% 2,4′ MDI | Dow |
| MOR-FREE ™ L-Plus 1 | solventless prepolymer, different | Dow |
| | from the present invention | |
| MOR-FREE ™ ELM | solventless prepolymer, contains | Dow |
| 415 | polymerized units of TDI⁽¹⁾ | |

note
⁽¹⁾contains less than 0.1% by weight of TDI monomer

TABLE 1C
Plastic Films

| | | Vendor |
|---|---|---|
| Product name | Description | name |
| PE | polyethylene PE P1-67, thickness 80 μm, | |
| | with slip and antiblocking additives | |
| PET | polyethylene terephthalate | |
| PET EMP | PET, Thickness 12 μm | Coveme Co. |
| PE(EVOH) | polyethyene, 50 μm thick, with layer of | |
| | poly(ethylene vinyl alcohol), 5 μm thick | |
| OPA | oriented polyamine film OPA KNP, | |
| | thickness 15 μm | |

Analysis for the presence and amount of MDI was performed as follows. HPLC analysis was done using Agilent Technologies™ 1100 instrument and results were analyzed using OpenLAB™ CDS C.01.06 software. Samples were prepared by dissolving 0.2 g of sample in 10 ml of solvent that contained methanol, 200 g THF and 50 μL of catalyst and filtering with 0.2 m PTFE filter. The pump was set to 1.5 mL/min and the injected sample volume was 5 μL. Zorbax™ RX-C8 (4.6 mm×150 mm×5 μm) column was used for the analysis. Calibration was done using pure 4,4′ MDI in a concentration as close to expected as possible.

Analysis for % NCO was performed according to the test method ASTM D2572-97.

### Formation of Isocyanate Functional Prepolymer (FPA)

In a pre-heated (60° C.) round bottom flask of 3000 mL under N2 atmosphere, ISONATE™ 125M was added, previously melted in a water-bath. The polyol or polyol blend (as shown in Table 2) was pre-heated to 50° C. and added to hot ISONATE™ 125M. The mixture was kept under stirring, waiting for any exothermic phenomena to be completed, and then was heated up to 80-85° C. Mixture was kept under stirring at 80° C. for 1.5 hour. Residual % NCO was checked via titration. Once the values measured was close to the theoretical value, the solution was cooled down at 40-50° C. and transferred in metallic cans. The cans were filled with nitrogen to prevent reaction with moisture and stored in freezer waiting for the stripping step.

The resulting reaction product mixture (RPA) was then subjected to distillation without solvent as follows: evaporator temperature of 175° C., condenser temperature of 45° C., pressure of 0.04 mbar, feed rate of 0.6 to 1.2 kg/hour, wiper speed of 360 U/minute, using a laboratory-scale UIC KDL 5 distillation device, using a single pass. It is contemplated that when such a process is performed at larger scale, two passes may be needed.

Table 2 shows the reactants that were used for making three prepolymers. Also shown are the resulting viscosities (Brookfield viscometer, 25° C.) of each prepolymer.

TABLE 2
Reactants for Prepolymer (weight %)

| Material name | Prepolymer 1 | Prepolymer 2 | Prepolymer 3 |
|---|---|---|---|
| ISONATE ™ 125M | 33.65% | 33.65% | 33.65% |
| Voranol PUP 2025 | 66.35% | | 53.08% |
| Voranol CP3055 | | 66.35% | 13.27% |
| Viscosity | 15000 mPa*s | 17000 mPa*s | 34000 mP*s |

Results of the prepolymer synthesis followed by distillation are shown in Table 3. Residual MDI is reported as weight % based on the weight of the prepolymer. Viscosity was measured with a Brookfield viscometer model DVIII, following ASTM method D2196, using the spindle and rpm shown. Results of duplicate syntheses are shown.

TABLE 3
Results of Prepolymer synthesis and distillation

| | viscosity 25° C. | viscosity 40° C. | | Residual |
|---|---|---|---|---|
| Pre- | (spindle × rpm) | (spindle × rpm) | | MDI |
| polymer | (mPa*s) | (mPa*s) | | (%) |
| 1 | 16700 (5 × 20) | 5010 | (4 × 20) | 0.13 |
| 1 | 17000 (5 × 20) | 5250 | (4 × 20) | 0.19 |
| 2 | 34680 (5 × 10) | 11280 | (5 × 20) | 0.07 |
| 2 | 34080 (5 × 10) | 10860 | (5 × 20) | 0.09 |
| 3 | 16940 (4 × 10) | 5050 | (4 × 20) | 0.13 |
| 3 | 16740 (4 × 10) | 5050 | (4 × 20) | 0.08 |

The following are Examples of the first, second, and third aspects of the invention

### Formation of Pack II

TABLE 4
pack II formulations (parts by weight)

| Material name | PL1 | PL2 | PL3 | PL4 | PL5 |
|---|---|---|---|---|---|
| CP-755 | 67.68 | | | 68 | |
| Isonate ™ 125M | 12.54 | 10.0 | 8.45 | 12 | |
| Polyol R | 19.78 | 88.90 | 91.00 | | |
| Polyol S | | | | 20 | |
| TMP | | 1.10 | 0.55 | | |
| APP1 | | | | | (1) |
| PEP1 | | | | | (1) |
| SPECFLEX ™ 2306 | 5 | 2 | 2 | 2 | (1) |

Note
(1): Amounts not shown

Regarding PL1, PL2, and PL3 in Table 4: the ingredients shown were mixed in the amounts shown for 2 hours under stirring at 80 to 85° C. The result was cooled to room temperature, and then Specflex™ 2306 was added. Regarding PL4 in Table 4: the CP-755 and Isonate™ 125M were mixed in the amounts shown for 2 hours under stirring at 80 to 85° C. The result was cooled to room temperature, and then Polyol S and Specflex™ 2306 were added.

Various 2-pack adhesive compositions were made by blending pack I and pack II in a high-speed mixer at 1800 rpm for 1 to 2 minutes. The compositions were as shown in Tables 5A, 5B, and 5C. Inventive examples are labeled “Ex” and comparative examples are labeled “CEx.” The amounts shown are parts by weight.

TABLE 5A
Inventive 2-pack adhesive compositions (parts by weight)

| | Ex 1 | Ex 2 | Ex 3 | Ex 4 | Ex 5 | Ex 6 |
|---|---|---|---|---|---|---|
| Pack I | | | | | | |
| Prepolymer 1 | 100 | 100 | 100 | | | |
| Prepolymer 3 | | | | 100 | 100 | 100 |
| Pack II | | | | | | |
| PL1 | 25 | | | 25 | | |
| PL2 | | 35 | | | 35 | |
| PL3 | | | 35 | | | 35 |

TABLE 5B
Inventive 2-pack adhesive compositions (parts by weight)

| | Ex 7 | Ex 8 | Ex 9 | Ex 10 |
|---|---|---|---|---|
| Pack I | | | | |
| Prepolymer 1 | | | 100 | 100 |
| Prepolymer 3 | 100 | 100 | | |
| Pack II | | | | |
| PL 4 | | 35 | | 35 |
| PL 5 | 20 | | 20 | |

TABLE 5C
Comparative 2-pack adhesive compositions (parts by weight)

| | CEx 1 | CEx 2 | CEx 3 | CEx 4 | CEx 5 |
|---|---|---|---|---|---|
| Pack I | | | | | |
| Prepolymer 2 | 100 | | | | |
| MOR-FREE ™ | | 100 | | (2) | |
| ELM-415A | | | | | |
| MOR-FREE ™ L-Plus | | | 100 | | (2) |
| Pack II | | | | | |
| CR-84 | 20 | 40 | 45 | | |
| CR 87-550 | | | | (2) | |
| CR 121 | | | | | (2) |

note
(2): These are commercially available combinations of pack I and pack II, and they were used at amounts specified by the Technical Data Sheets that describe each product.

The reactivity of the 2-pack adhesive compositions was measured as follows. Immediately after mixing the two packs together, the viscosity of the adhesive composition was measured using Brookfield Rheometer DVIII-ULTRA, with spindle SC4-28, thermostatted with Brookfield Thermosel™ at 45° C., at rpm setting that was adjusted for each sample to put the torque into the correct measurement range for the viscometer.

The reactivity is assessed by two measures. First, we consider the pot life, which is the time required for the viscosity to double from the initial viscosity at the time when the two packs are first mixed together. It is desired that the pot life be 20 to 60 minutes. Second, we consider the bond strength developed by the adhesive 24 hours after forming a laminate. It is desired that the bond strength be as high as possible in 24 hours after forming a laminate. It is contemplated that the bond strength is an indicator of the extent of the cure reaction.

In a first pot life test, various samples were made that were identical to Ex 2 except that the amount of Specflex™ 2306 was varied from 0 to 5 parts by weight (pbw, based on 100 pbw of all polyols in pack II other than Specflex™ 2306) in pack II. The level of 2 parts by weight is identical to Ex 2. The results were as follows:

TABLE 6
Pot life of analogs of Ex 2

| Specflex ™ 2306 (pbw) | pot life (min) |
|---|---|
| 0 (comparative) | >60 |
| 2 | 45 |
| 3 | 32 |
| 5 | 25 |

The sample with 0 parts is a comparative example, and it has unacceptably long pot life. The other samples show acceptable pot life.

In a second pot life test, analogs of Ex 2 and Ex 3 were made with varying amounts of Specflex™ 2306, as in the first pot life test. Also, CEx 3 was tested. The results were as follows:

TABLE 7
Pot life of analogs of Ex 2 and Ex 3

| Analagous Example | Specflex ™ 2306 (pbw) | pot life (min) |
|---|---|---|
| CEx 3 | 0 | 23 |
| Ex 2 | 2 | 48 |
| Ex 2 | 3 | 22 |
| Ex 2 | 5 | 19 |
| Ex 3 | 2 | 45 |
| Ex 3 | 3 | 25 |
| Ex 3 | 5 | 16 |

All the inventive examples in Table 7 showed acceptable pot life, though the performance of the examples with 2 and 3 pbw of Specflex™ 2306 showed the most desirable pot lives. The pot life of 23 minutes (as shown by CEx 3) is an example of a pot life known to be useful in industrial practice.

Laminates were prepared two different ways: by hand and by machine.

To prepare laminates by hand, an oil heated roll hand laminator (nip temperature of 66° C. (150° F.); running speed of 10.2 cm/sec (20 ft/min)) and a dried coating weight of approximately 2.44 to 3.26 g/m² (1.5-2.0 pounds/ream) were utilized. The laminates were prepared sheet by sheet with an approximately (30.5 cm by 25.4 cm (12 inches by 10 inches) coated area through K-coater. The sample was formulated as 30 weight percent solids in ethyl acetate to control material viscosity and then coated onto a primary film; the coated primary film was oven dried (90° C.; approximately 1 minute). Then the coated primary film was laminated onto a secondary film with the oil heated roll hand laminator (approximately 276 kPa (40 psi)); then the laminates were cured at approximately 22° C. (room temperature) for seven days.

To prepare laminates by machine, laminates were made with a NordMeccanica Labo Combi 400. Premixed pack I and pack II were applied in the application pan. Application cylinders were heated at 50° C. For each lamination, the coating weight was 1.8 to 2.2 g/m2.

It is desired that the amount of isocyanate groups decays rapidly after the laminate is made. To measure this NCO decay, the intensity of the NCO peak in the FT-IR spectrum was monitored. The amount of isocyanate was measured when the laminate was newly made, and this initial NCO amount is labeled NCO(0). As time progressed, at each time “t” the NCO was measured and labeled NCO(t), and the ratio NCO(t)/NCO(0) is reported as a function of time.

NCO decay was measured using Ex 1, Ex 2, Ex 3, CEx 3, and CEx 4. The results were as follows.

TABLE 8
NCO decay results (NCO(t)/NCO(0) ratio)

| | | Ex 1 | Ex 2 | Ex 3 | CEx 3 | CEx 4 |
|---|---|---|---|---|---|---|
| 1 | day | 0.05 | 0.12 | 0.12 | 0.15 | 0.6 |
| 2 | days | 0.03 | 0.08 | 0.08 | 0.09 | 0.06 |
| 3 | days | 0.01 | 0.01 | 0.01 | 0.02 | 0.03 |

The inventive examples had better NCO decay results at 3 days than the comparative examples.

Bond strength was measured as follows. T-peel bond strength was measured on a 15 mm-inch strip of laminate at a rate of 10.16 cm/min (4 inch/min) on an Instron tensile tester with a 50 N loading cell. Three strips were tested for each laminate and high and mean strength were recorded together with the failure mode. In cases of film tear and film stretch, the high value was reported and in other failure modes the average T-peel bond strength was reported. The bond strength was tracked after 1 day, 7 day, and 14 days of curing. Bond strength is reported as newtons (N) per 15 mm of width. Typical failure modes include:
AF—Adhesive failure (adhesive with primary substrate);
AT—Adhesive transfer (adhesive with secondary substrate);
AS—Adhesive split (cohesive failure of adhesive);
FT—Film Tear (substrate stretch or failure);
DL—Delamination;
TL—Tunneling.

Hand-made laminates were tested, using various inventive and comparative example adhesive compositions. Results were as follows.

TABLE 9
Bond Strength (N/15 mm) of Hand Laminated Samples

| | 1 day | | 3 days | | 7 days | |
|---|---|---|---|---|---|---|
| | N/15 | | N/15 | | N/15 | |
| | mm | comment | mm | comment | mm | comment |
| CEx 3 | 5.3 | | 5.5 | t PET | 4.8 | t PET |
| CEx 5 | 4.8 | | 6.6 | t PET | 4.9 | t PET |
| Ex 1 | 3.1 | AS | 3.3 | AS | 3.1 | AS |
| Ex 2 | 5.5 | PET FT | 3 | PET FT | 2.3 | AT |
| Ex 3 | 5.3 | PET FT | 4.5 | PET FT | 3.2 | PET |
| | | | | | | FT + AT |
| Ex 4 | 2 | AT | 2.7 | PET FT | 1.9 | AT |
| Ex 5 | 1.5 | AT | 1.7 | AT | 1.9 | AT |
| Ex 6 | 3.2 | AS | 2.6 | PET FT | 2.7 | PET FT |
| Ex 7 | 4.6 | PET FT | 3.8 | PET FT | 3 | PET FT |
| Ex 8 | 2.4 | AS | 3.4 | AS | 3.5 | PET FT |

Laminates were made by machine using first substrate OPA and second substrate PE(EVOH). Results were as follows.

TABLE 10
Bond Strength (N/15 mm) of machine laminated samples

| | after 7 days (N/15 mm) |
|---|---|
| EXP 5 | 11.8 FT |
| EXP 6 | 11.1 FT |
| EXP 7 | 10.8 FT |
| EXP 8 | 10.0 FT |
| EXP 9 | 11.9 FT |
| EXP 10 | 11.2 FT |

Additional machine-made laminates were tested after cure was complete, using OPA and PE(EVOH) films. Results were as follows. “s PE” refers to stretching of the PE film.

TABLE 12
Bond Strength (N/15 mm) of additional machine-made laminates

| | final strength |
|---|---|
| Ex 5 | 11.8 s PE |
| Ex 6 | 11.1 s PE |
| Ex 7 | 10.8 s PE |
| Ex 8 | 10.0 s PE |
| Ex 9 | 11.9 s PE |
| Ex 10 | 11.2 s PE |

It is desirable that the laminating adhesive forms a continuous layer between the surfaces of the two substrate films. It is believed that if some water is present during the curing reaction between pack I and pack II, some carbon dioxide forms. If the substrate films act as barriers to trap the carbon dioxide (as, for example OPA and PE(EVOH) films do), then the trapped carbon dioxide may form small bubbles that cause visible optical defects in the laminate.

Bubble formation in the laminates was evaluated by visual check. For this purpose, the following rating scale was used:

TABLE 13
Rating scale for bubble formation

| rating | description |
|---|---|
| 1 | Worst |
| 2 | Bad |
| 3 | Fairly Good |
| 4 | Good |
| 5 | Perfect |

Results of the bubble evaluation were as follows. The results labeled “External Layer” refer to laminates that are rolled onto a spool; samples in the external layer were assessed separately.

TABLE 14
Bubble evaluation at different lamination speeds

Lamination Speed (m/min)

| | External Layer | 100 | 150 | 200 | 250 |
|---|---|---|---|---|---|
| Ex 5 | 4 | 5 | 5 | 4 | 4 |
| Ex 4 | ⅔ | 5 | 5 | 5 | 3 |
| Ex 7 | ½ | ⅘ | 4 | 4 | 3 |
| Ex 6 | ¾ | 5 | ⅘ | 5 | 4 |
| Ex 8 | 3 | 5 | 5 | ⅘ | 4 |
| Ex 9 | 2 | 5 | 4 | ⅔ | 1 |
| Ex 10 | 3 | 5 | 5 | 5- | 4 |
| CEx 2 | ½ | | | | ⅔ |

The inventive examples have generally desirably low level of optical defects thought to be due to carbon dioxide generation, and almost all are better than Cex 2.

All of the inventive examples had acceptable pot life, acceptable cure time, and acceptable bond strength. When compared to comparative 2-pack adhesives that used a non-inventive commercial polyol in pack II, the inventive examples showed improved NCO decay and improved reduction of optical defects.

The following are Examples of the fourth, fifth, and sixth aspects of the present invention.

The following Pack II formulations were prepared by mixing the ingredients shown.

TABLE 15
Pack II formulations (parts by weight)

| | PL6 | PL7 | PL8 | PL9 |
|---|---|---|---|---|
| MOR-FREE ™ 88-138 | 4.0 | 4.0 | 4.1 | 2.0 |
| CR-89 | | | 95.9 | |
| Voranol PUP 425 | 38.4 | 45.5 | | |
| Polyol T | 57.6 | 45.5 | | |
| Polyol U | | | | 98.0 |
| SPECFLEX ™ 2306 | | 5.0 | | |

2-pack compositions were made by combining the ingredients as shown in Table 16.

TABLE 16
Inventive 2-pack adhesive compositions (parts by weight)

| | Ex 11 | Ex 12 | Ex 13 | Ex 14 |
|---|---|---|---|---|
| Pack I | | | | |
| Prepolymer 1 | 100 | 100 | | |
| Prepolymer2 | | | 100 | 100 |
| Pack II | | | | |
| PL6 | 17.0 | 19.3 | | |
| PL8 | | | 23.2 | |
| PL9 | | | | 22.9 |

Laminates were made and tested as described herein above. The adhesive composition was applied to PET substrate and then laminated to PE substrate. Bond strength was tested as described herein above. Bond strength was tested at 7 days after formation of the laminate and storage at room temperature. Bond strength was also tested after a boil-in-bag procedure.

The boil-in-bag procedure was as follows. A cured laminate structure (about 23 cm×28 cm (9 inches×11 inches)) was folded over to form a double layer such that the polyethylene film of one layer was in contact with the polyethylene film of the other layer. The edges were then trimmed with a paper cutter to obtain a folded piece about 13 cm×18 cm (5 inches×7 inches). The edges were then heat sealed to form a pouch with an interior size of about 10 cm×15 cm (4 inches×6 inches). The pouches were then filled 100 mL of 1/1/1 sauce (i.e., a blend of equal parts by weight of catsup, vinegar and vegetable oil) through the open edge. After filling, the pouch was sealed in a manner that minimized the air entrapped inside of the pouch. The filled pouches were then carefully placed in boiling water and kept immersed in the water for 30 minutes. When completed, the extent of tunneling, delamination, and/or leakage was compared with marked pre-existing flaws. The bags were then emptied and at least three strips were cut from the pouches and T-peel bond strength was measured as soon as possible thereafter.

Results of the bond strength tests were as follows.

TABLE 17
Bond Strength Test Results

| | after 7 days (N/15 mm) | after boil-in-bag (N/15 mm) |
|---|---|---|
| Ex 11 | 11.4 PET FT | 1.55 AS |
| Ex 12 | 8.29 PET FT | 1.1 AS |
| Ex 13 | 7.8 PET FT | 2.8 PET FT |
| Ex 14 | 7.4 PET FT | 2.1 PET FT |
| CEx 1 | 13.6 FT | 2.4 AS |
| CEx 2 | 11.5 PET FT | 2.3 AS |
| CEx 3 | 7.1 PET FT | 2.2 AS |

All of the inventive examples showed acceptable bond strength results.

1. A 2-pack adhesive composition comprising
I) pack I, which comprises a prepolymer composition (PCB), wherein the prepolymer composition (PCB) comprises one or more isocyanate functional prepolymers (FPA),
wherein the isocyanate functional prepolymer (FPA) comprises polymerized units of 4,4′ MDI, and
wherein the prepolymer composition (PCB) comprises a total amount of all isocyanate monomers of 0 to 0.2% by weight based on the weight of prepolymer composition (PCB),
and
II) pack II, which comprises one or more amine functional polyols.

2. The composition of claim 1, wherein the pack II additionally comprises one or more phosphate functional polyols.

3. The composition of claim 1, wherein the pack II additionally comprises one or more polyurethane polyols.

4. The composition of claim 1, wherein the isocyanate functional prepolymer (FPA) comprises polymerized units of 4,4′ MDI in an amount of 50% or more, by weight based on the weight of all polymerized units of isocyanate monomers in the isocyanate functional prepolymer (FPA).

5. The composition of claim 1, wherein the pack II comprises the amine functional polyol in an amount of 0.5% to 10%, by weight based on the weight of the pack II.

6. A process for producing a laminate comprising
a) bringing the pack I and the pack II of the composition of claim 1 into contact with each other to form a laminating adhesive,
b) applying a layer of the laminating adhesive to a surface of a first film,
c) then bringing the layer of the laminating adhesive into contact with a surface of a second film to form a laminate.

7. A laminate produced by the method of claim 5.

8. A 2-pack adhesive composition comprising
I) pack I, which comprises a prepolymer composition (PCB), wherein the prepolymer composition (PCB) comprises one or more isocyanate functional prepolymers (FPA),
wherein the isocyanate functional prepolymer (FPA) comprises polymerized units of 4,4′ MDI, and
wherein the prepolymer composition (PCB) comprises a total amount of all isocyanate monomers of 0 to 0.2% by weight based on the weight of prepolymer composition (PCB),
and
II) pack II, which comprises one or more phosphate functional polyols.

9. A process for producing a laminate comprising
a) bringing the pack I and the pack II of the composition of claim 8 into contact with each other to form a laminating adhesive,
b) applying a layer of the laminating adhesive to a surface of a first film,
c) then bringing the layer of the laminating adhesive into contact with a surface of a second film to form a laminate.

10. A laminate produced by the method of claim 9.
